(19) United States
(12) Patent Application Publication
(10) Pub. No.: US 2012/0143634 A1
(43) Pub. Date: Jun. 7, 2012

(54) Systems, Methods, and Computer Program Products for Processing Insurance Claims

(75) Inventors: Peter Beyda, Franklin Lakes, NJ (US); Archana Seth, Short Hills, NJ (US); Ira Apsel, Mt. Sinai, NY (US); Michael Gitter, Lake Hopatcong, NJ (US)

(73) Assignee: American International Group, Inc., New York, NY (US)

(21) Appl. No.: 13/310,528

(22) Filed: Dec. 2, 2011

Related U.S. Application Data
(60) Provisional application No. 61/419,133, filed on Dec. 2, 2010.

(51) Int. Cl. G06Q 40/08

(52) U.S. Cl. 705/4

(57) ABSTRACT

Systems, methods, and computer program products for processing a claimant's insurance claim provide the architectural components to facilitate a common philosophy and infrastructure for processing claims in a consistent manner. A highly cohesive infrastructure can be provided that allows for legacy systems to participate in a service-oriented manner.

### CROSS-REFERENCE TO RELATED APPLICATIONS

This patent application claims the benefit of priority to U.S. Provisional Patent Application No. 61/419,133, filed on Dec. 2, 2010, and entitled “System, Method, and Computer Program Product for Processing Insurance Claims,” which is incorporated in its entirety herein by this reference.

### BACKGROUND

The processing of insurance claims can be a very significant (if not the largest) cost item for an insurance company and can be the most memorable experience a customer has with the insurance company. System-wide inefficiencies can lead to inaccuracies in assessing claims, delays in paying settlements, losses from fraud, expenses from litigation, citations for regulatory non-compliance, and losses in customer retention.

For example, different regional offices or business units within an insurance company may operate on a variety of legacy platforms which have been implemented at different periods of time. Many critical functionalities may be missing from certain regions or business units. Certain functionalities may be redundant across different systems in use in the same company. Non-standardized data, applications, and interfaces can create integration barriers. Couplings between applications, data, and rules may create an inflexible system with limited scalability and modifiability.

Improving the processing of claims can help an insurance company increase its operational efficiency and customer satisfaction. Insurance carriers continue to seek systems and methods for claims processing which promote quickly settling claims, retaining customers, preventing fraud against the company, quickly and accurately setting reserves, and streamlining workflow.

### SUMMARY

This disclosure is directed to systems, methods, and computer program products for processing insurance claims. The computer-implemented architecture provided can include components which facilitate a common philosophy and infrastructure for processing claims in a consistent manner across the different geographical regions and business units of an insurance company. A highly-cohesive infrastructure can be provided that allows for legacy systems to participate in a service-oriented manner and provides loose coupling between systems to allow components to be selectively chosen at run time via a predetermined policy.

In some embodiments, a system for processing insurance claims can include a physical computer-readable medium including a global claims online application, a physical computer-readable medium housing an enterprise messaging system having an enterprise service bus (ESB) adapted to route messages for processing service requests, and a processor adapted to execute the global claims online application contained on the physical computer-readable medium and to deploy and execute services of a service-oriented architecture through the ESB. The global claims online application can include a user interface layer adapted to allow a user to interface with the global claims online application, a workflow management module adapted to determine a sequence of work objects to be completed for the insurance claim and to determine which user of a set of users works on each of the work objects relating to the insurance claim, and a business rules management module adapted to manage logical rules for segmenting the insurance claim or a feature thereof to follow a predetermined workflow.

In some embodiments of a method for processing insurance claims, the method includes employing a process server to deploy and execute services of a service-oriented architecture comprising computer executable instructions stored on a tangible computer-readable medium. The executable instructions can perform steps for processing the insurance claim. A user interface layer of a global claims online application can be used to enter data about an insurance claim into the global claims online application. Service requests can be processed via an enterprise service bus (ESB). Business data services can be invoked using the global claims online application user interface layer to store the entered insurance claim data in a claim transactional database. Business orchestration can be invoked using a workflow management module of the global claims online application and the ESB to perform a sequence of work objects to be completed for processing the insurance claim.

In some embodiments, a non-transitory, tangible computer-readable storage medium can include instructions for processing insurance claims. The instructions, when executing on one or more computing devices, perform steps for processing an insurance claim. A web server can be used to display a user interface layer of a global claims online application on a user interface browser to receive data about an insurance claim. Service requests can be processed via an ESB. Business data services can be invoked in response to input from the global claims online application user interface layer to store the entered insurance claim data in a claim transactional database. Business orchestration can be invoked using a workflow management module of the global claims online application and the ESB to perform a sequence of work objects to be completed for processing the insurance claim.

As will be appreciated, the systems, methods, and computer program products disclosed herein are capable of being carried out in other and different embodiments and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIGS. 1A-C are a schematic diagram of an embodiment of a computer-implemented system for processing insurance claims.

FIGS. 2A-C are a flow diagram that illustrates an exemplary embodiment of a method for processing insurance claims in keeping with principles of the present disclosure.

### DETAILED DESCRIPTION OF EMBODIMENTS OF THE INVENTION

Systems, methods, and computer program products for processing insurance claims are described herein. In the following detailed description, references are made to the accompanying drawings that form a part hereof, and in which are shown by way of illustration, specific embodiments or examples. These embodiments may be combined, other embodiments may be utilized, and various changes may be made without departing from the spirit or scope of the present disclosure. The following detailed description is therefore not to be taken in a limiting sense.

Aspects of the present disclosure allow an insurance company or other entity to efficiently and effectively process insurance claims using a global claims online application in a customer-centric, controlled manner that promotes customer satisfaction and retention. The system can be used to execute a holistic claims strategy across general insurance products and services. The systems can allow an insurance company to implement standardized and repeatable processes globally, automate claims when possible, and properly segment the remaining claims.

The global claims online application can be operated in a web-based platform and can permit selective access through portals available to internal employees of the insurance company and to external participants in the insurance claim process, including its vendors, third party administrators, and claimants, for example. Examples of user categories for employees of the insurance company include: FNOL Capturer, Adjuster, Fraud Adjuster, Claims Receivable, Claims Assistants, Administrative, Team Leader, Manager, Fraud Manager, Security, Financial Crime Unit, Claims Account Relationship Managers, Systems, Claims Performance Auditors, Internal Audit Division. The access level for each type of user can vary by work task of a set of work tasks for processing an insurance claim. The global claims online application can establish core claim handling best practices by user category and by line for larger claims, introduce technical guidelines, optimize processes, and ensure consistent file quality measurement.

The global claims online application can capture economies of scale available to the insurance company, increase the automation/standardization of the claims processing steps, eliminate unnecessary process steps, and help drive continual process improvements. The global claims online application can streamline investigations via its digital reporting capabilities.

In some embodiments, the system uses a centralized, extensible and resilient data and process model, providing consistency across a company's operation. Data and applications can be centralized in a single data center through the global claims online application to provide economies of scale and reduce maintenance costs. Migrating data from different repositories to a standard data definition (such as one based on IBM® Insurance Application Architecture (IAA) from International Business Machines Corp. of Armonk, N.Y., for example) and model can enable the sharing of data across regions while providing a similar level of functionalities available in each region. Standardizing common data definitions can facilitate the reporting capabilities across business units and regions. Using a standard data model provides the flexibility to deliver business requirements across different lines of business (LOBs) and product lines and enables ready integration with third-party systems (e.g., brokers, repair shops, etc.). The consolidated data can facilitate the generation of a single view, or “identity,” of a particular customer throughout the company to facilitate reporting capabilities relating to a customer that is a multi-national company (MNC).

Embodiments of the system allow for the integration of legacy applications. Embodiments of the global claims platform use a service-oriented architecture (SOA). Existing systems can link with the global claims platform according to principles of the present disclosure via the services-based architecture. The global claims platform enables access to existing applications and data. Legacy systems can be integrated with the architecture and systems of the global claims platform so that an insurance company can migrate systems over time business function by business function, rather than requiring complete conversions before becoming operational.

Through the global claims online application, an insurance company can improve the First Notice of Loss (FNOL) data management process (e.g., by creating forms on the fly and recording claim information in searchable data fields). Using the global claims online application, a user can auto-populate screens relating to processing a claim in a call center. The user can identify the caller/claimant and pre-populate screens with information retrievable by the global claims online application related to the claimant. For example, the global claims online application can auto-populate loss history in service representative screens during the FNOL interview. The global claims online application can help create rules-driven scripts with built-in skip logic to facilitate the information capture from the claimant during the FNOL.

The global claims online application can help the user verify coverage during the FNOL. The global claims online application can facilitate the handling of multi-national customer claims by providing a single customer “identity” throughout the entire insurance company. The global claims online application can provide a holistic view of customer relationships. The global claims online application can yield improved MNC client claims handling capability by using enhanced customer reporting, cross-business coordination, and improved systems/data architecture and by applying the best available expertise of the insurance company's personnel on each claim.

For example, the rules-driven workflow provided by the global claims online application can make Special Account Instructions for a given customer available to service center representatives and adjusters throughout its operations. In one aspect, the global claims online application can ensure global compliance with Special Account Instructions by implementing a template housed in a global repository.

The global claims online application can establish workflow tasks and notifications (e.g., notifying adjusters of FNOL and automating escalation of claims to different segments). The global claims online application can provide skill-based and language-based routing of calls across locations to streamline workflow and improve the utilization of the available employee skill set. The global claims online application can automate a segmentation process so that a given claim is routed to the appropriate handler. The global claims online application can streamline overall claims processing by using rules-driven and role-driven business components.

The global claims online application can automatically segment an insurance claims to a predetermined processing team of users based on logical business rules stored in the global claims system. The global claims online application can create a work item in the work basket of the designated team of users and a work list notification to notify the team that a work item has been added to their work basket. In some embodiments, the global claims online application can identify a feature of the insurance claim to be segmented.

The global claims online application can execute segmentation rules for policy detail features. The global claims online application can validate policy details of the claim to identify any dedicated adjuster association for those details. When there is an adjuster so associated, the global claims online application can automatically assign the dedicated adjuster for the associated policy detail features created on the claim. The global claims online application can create a work list notification and send it to the assigned adjuster. In some embodiments, an authorized user can re-assign an assigned insurance claim and/or feature of an insurance claim to another processing team or individual.

The global claims online application can use a rules engine to automate the claims adjudication process where feasible (e.g., by identifying subrogation opportunities, establishing claim segmentation opportunities, and establishing “one-and-done” scenarios). In one aspect, the global claims online application can establish one-and-done categories to settle specific claims during the FNOL. The global claims online application can help create high frequency/low-complexity (HF/LC) claims processing during the FNOL across locations through improved segmentation, automated rules-based processes, and dedicated adjusters.

The global claim online application can provide a means for ready electronic document sharing, retention, and deletion. Paper documents can be digitized, and the information found therein can be captured and rendered searchable through an optical character recognition (OCR) module of the global claims online application. The documentation bundle can be shared between users of the global claims online application at different geographic locations. The global claims online application can help integrate the claim resolution process with service providers involved in the settlement (e.g., direct repair facilities and car rental agencies).

The global claims online application can provide the ability for virtual claims handling through integrated document and content management. The central electronic repository of claim information can facilitate improved collaboration between different actors in the claims handling process and allow the insurance company to assign resources based on availability and experience without requiring geographic proximity.

The global claims online application can increase the retention of employees involved in the claims process. In one aspect, the global claims online application can improve the toolset for adjustors to facilitate their everyday tasks, which can help increase the adjustor's job satisfaction. For example, the global claims online application can help aggregate claim documentation electronically in a central location for an adjuster. Workers' compensation rate tools can be made available to the adjuster through the global claims online application. The adjuster's ability to make a loss evaluation and report the same can be facilitated through the global claims online application. The global claims online application can improve the operation of the insurance company by establishing rules that include a trigger point for setting aside reserves for selected claim types at an early stage of the claims adjudication process.

The global claims online application can drive greater accuracy in indemnity payouts and help manage acceptable risks in the process. The global claims online application can increase claim adjudication quality and increase the consistency of claims handling through the use of the business rule engine. The global claims online application can create automated “push” task reminders and provide enhanced diaries to increase the timeliness of the claim adjudication process.

The global claims online application can increase the satisfaction of customers. For example, the global claims online application can decrease the time to resolution for a given claim and improve the customer's ease of interaction with the insurance company during the claim handling process. The global claims online application can establish rules that escalate the handling of certain claim types. The global claims online application can provide a customer with round-the-clock (twenty-four hours a day, seven days a week) availability to the claims systems. The global claims online application can provide a customer with multi-channel self-service options (e.g., web, email, SMS, etc.) across the entire value chain (e.g., notify loss, report information, notifications, self-service, access to claim records). Through one or more available portals into the global claims online application, the customer can obtain online tracking of the customer's claim status, obtain guidance on the claims handling process, and gather information on the required documentation for the claims handling process.

User portals (e.g., customer, vendor, agent) and business to business (B2B) interfaces (e.g., third party administrators) provide multi-channel access for user interactions with the global claims online application. Role-based user interfaces can increase productivity by providing ready access to common functions for a particular user.

The global claims online application can provide multi-channel automated notifications to clients and other involved parties (e.g., status update, required documentation missing) to further facilitate the claims handling process. For example, the global claims online application can help manage customer expectations for next steps by providing electronic notifications at predetermined milestones along the claims handling process.

The global claims online application can increase automation for example by establishing rules that allow for the reserving of selected claims types at an early stage of the claims adjudication process. The global claims online application can settle claims through multiple channels (e.g., ACH, EFT, checks). The global claims online application can support multiple languages and multiple currencies for both reserving and settlement.

The global claims online application can help an insurance company obtain control over the claims handling process. The global claims online application can help the management team of an insurance company arrive at a consistent performance management system.

The global claims online application can help ensure regulatory compliance by establishing rules-based forms and scripts for the claims processing team to use and follow while processing insurance claims. The global claims online application can automate the application of internal and governmental regulatory mandates. The global claims online application can help the insurance company comply with government-mandated procedures for the handling of foreign assets. The global claims online application (e.g., its security features) can help the company adhere to privacy and security regulations. The ability to modify the rules in the rule engine of the global claims online application can help the insurance company incorporate updates to industry data or internal codes.

The global claims online application can use a single application instance and multiple data instances as needed (e.g., regulatory reasons) to facilitate standardized reporting resulting from the common application and storage structure. The rules-based application of the global claims online application can create consistency across the handling process, including segmentation and assignment. The rule engine provides flexibility in the application to make updates to business rules quickly and with less effort than is required to support hard-coded rules.

The global claims online application can allow for “countrification” through its configuration. The global claims online application can allow for the customization of the system for region-specific needs and regulatory compliance, while maintaining a single instance of the application code base.

The global claims online application can facilitate cost-effective audit control to maintain quality standards and counter-balance reduced process steps. The global claims online application can help evaluate the performance of TPAs, vendors, and employees against a standardized set of metrics. The global claims online application can provide needed information to support closed-file and open-file review. The global claims online application can utilize analytic models to identify fraud flags.

In embodiments of a system for global online claims processing, a service-oriented architecture (“Global Claims architecture”) is used. The Global Claims architecture is scalable such that new countries or regions may be added seamlessly and with minimal effort.

Local requirements can be based on guidance at the enterprise level. The service-oriented design allows for guidance in the form of a set of contracts of behaviors and local governance to implement the contract. When a process is initiated, the physical endpoints or services can meet both enterprise guidance and local needs and are selected via late binding at run time. Therefore, the actual process meets local needs and is guided by the principles provided by corporate guidance and governance. Dynamic service selection can be based on content, context, and the requested contract.

A Service Registry and Repository can be used to hold and select the services that are composed to create a given business process. The registry and repository provide a means to store information about the services that are available in the enterprise such that this information is available to a run time process and to facilitate the development process.

The Service Registry and Repository implemented on top of an enterprise service bus (ESB) can act as a service locator, which locates services at run time that meet the criteria based on context, contract and content. The ESB can implement the following capabilities: transformation, routing, adaptation, orchestration, and mediation. The capabilities of an ESB can solve many of the problems of a global claims solution. The ESB's ability to carry out transformation, routing, conversion, etc. can allow many different systems, including legacy systems, to participate transparently in an enterprise-wide solution.

The Global Claims architecture can include an operational data store (ODS). The ODS comprises a database adapted to integrate data from multiple sources to make analysis and reporting easier. Because the data originates from multiple sources, the ODS includes features adapted to clean data, resolve redundancies and inconsistencies between different data sources, and to integrate data while checking against business rules for integrity. The ODS can be designed to contain low level or atomic (indivisible) data with limited history that is captured “real time” or “near real time” as opposed to the much greater volumes of data stored in a data warehouse generally on a less frequent basis.

The Global Claims architecture can have one or more claim data warehouse(s). The claim data warehouse is a repository for storing integrated information related to claims. Information can be loaded into the warehouse from the operational data and transactional stores. Information can be cleansed and organized for efficient query and analysis.

Data marts can be provided which are subsets of the data in the claim data warehouse. Data marts can be consolidated and summarized to provide efficient reporting and analysis for a specific set of user requirements.

The Global Claims architecture can have a central claims Transactional Data Store (TDS). The lookup of claim data can be greatly simplified by having one TDS for all claims.

A schema repository—a database used to store and manage a group of schemas including all versions of those schemas, and their associated user databases—can also be provided. A database schema comprises a collection of meta-data that describes the relations in a database. A schema can be simply described as the “layout” of a database or the blueprint that outlines the way data is organized into tables. In one arrangement, the schema can be described using Structured Query Language (SQL) as a series of “create” statements that may be used to replicate the schema in a new database.

A business rules engine and a process server can be provided. All business rules can be housed in the business rules engine. The process server can house orchestration-related rules.

A modeler can be provided that carries out business process modeling for complex business processes. Any suitable modeler can be used, such as IBM WebSphere® Business Modeler from IBM, for example. Business processes that run in the process server can be modeled using the WebSphere® Business Process Modeler.

In some embodiments, a system for processing insurance claims can include a physical computer-readable medium including a global claims online application, a physical computer-readable medium housing an enterprise messaging system having an enterprise service bus (ESB) adapted to route messages for processing service requests, and a processor adapted to execute the global claims online application contained on the physical computer-readable medium and to deploy and execute services of a service-oriented architecture through the ESB. The global claims online application can include a user interface layer adapted to allow a user to interface with the global claims online application, a workflow management module adapted to determine a sequence of work objects to be completed for the insurance claim and to determine which user of a set of users works on each of the work objects relating to the insurance claim, and a business rules management module adapted to manage logical rules for segmenting the insurance claim or a feature thereof to follow a predetermined workflow. The business rules management module of the global claims online application can also be adapted to manage logical rules for determining whether an insurance claim can be adjudicated automatically, such as those falling in to a predetermined HF/LC category.

The global claims online application can include a business event monitoring module adapted to provide real-time tracking of claim processing. The global claims online application can include an alerts and notifications module adapted to provide users operational information. The global claims online application can include a logging and audit trail module adapted to monitor the activities of the global claims online application and provide a log thereof.

The system can include a web server operably arranged with the global claims online application. The web server can be adapted to display the user interface layer of the global claims online application on a user interface browser to receive requests from a user and send responses to the user.

The system can include a global claims queue module operably arranged with the processor through the ESB. A physical computer-readable medium can be provided that houses a web services cluster adapted to invoke services of the service-oriented architecture, process orchestration, and read/write to queues of the global claims queue module.

The system can include a physical computer-readable medium housing a perimeter security application adapted to provide a web access management system with different access permissions. The processor is adapted to execute the perimeter security application.

The system can include a global claims data repository operably arranged with the processor through the ESB. The global claims data repository can be adapted to store integrated information related to an insurance claim. The system can include a data integration hub which can be operably arranged with the processor through the ESB. The data integration hub can be adapted to invoke a data transformation service of the service-oriented architecture to integrate claims data.

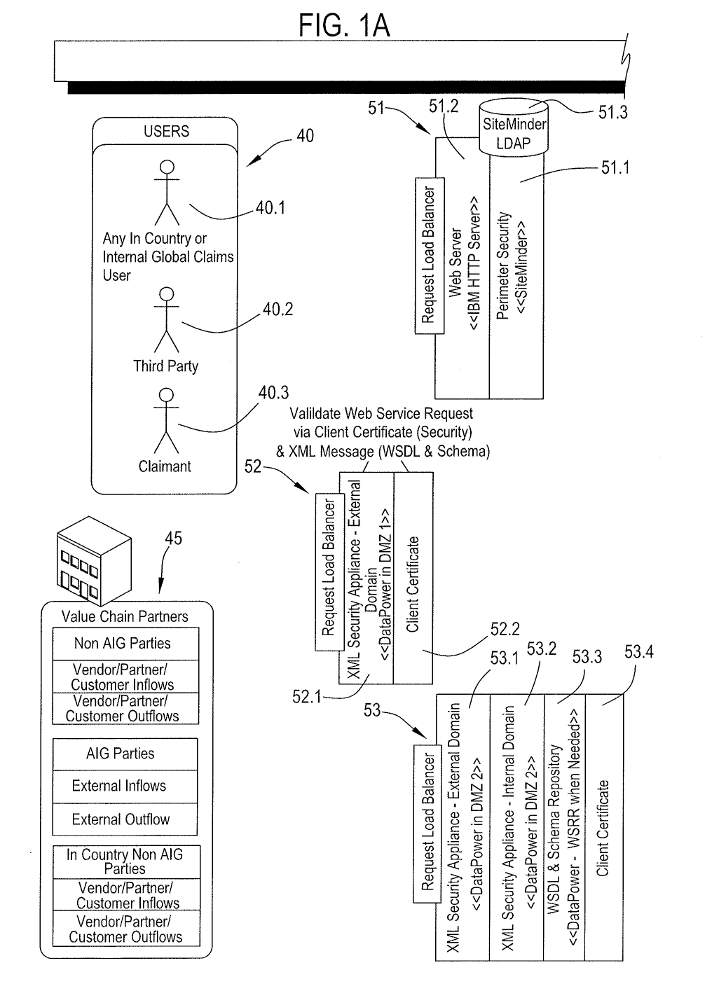

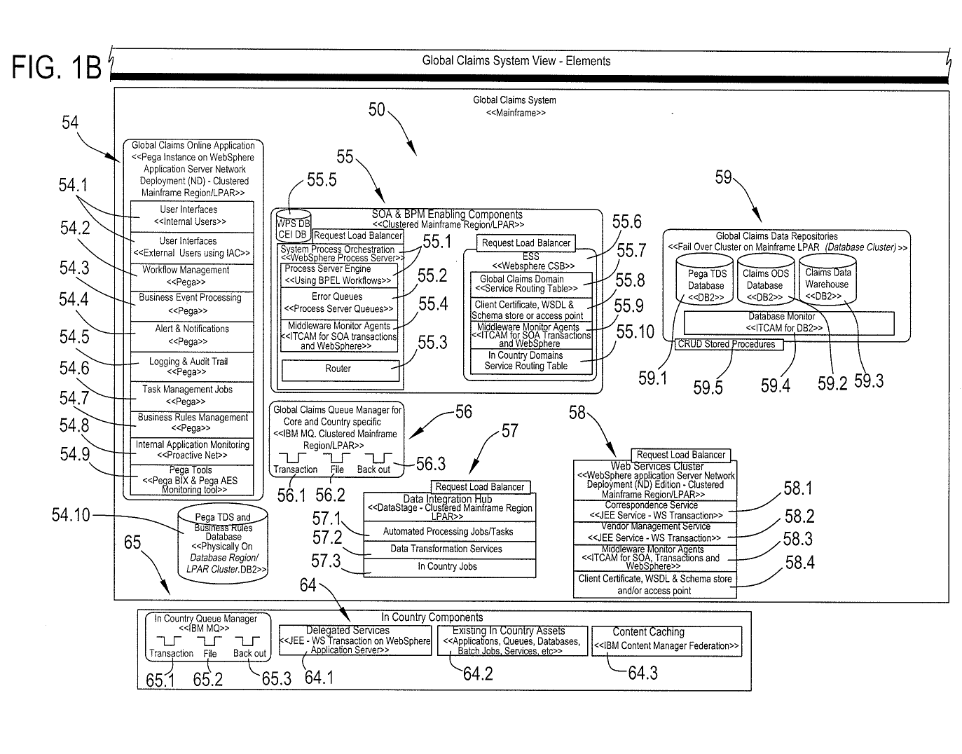

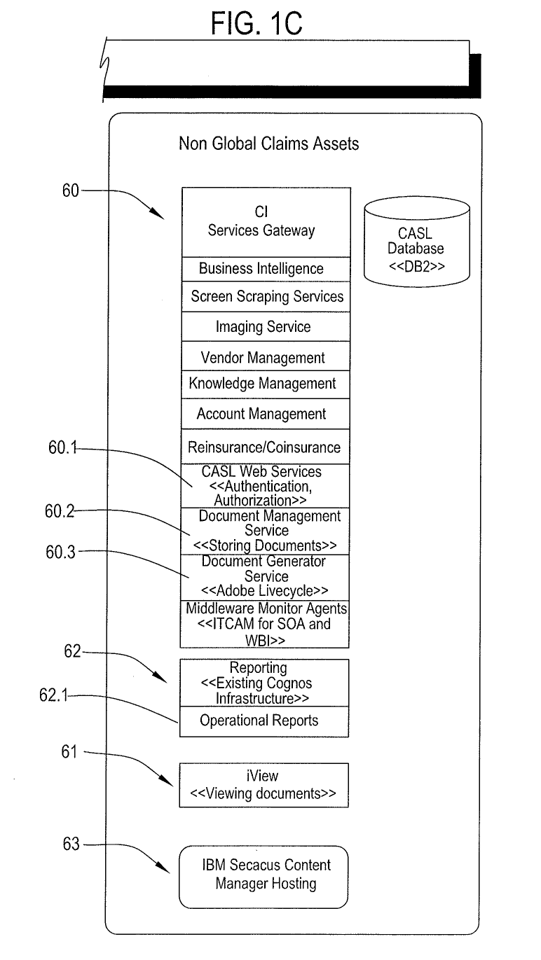

Turning now to the Figures, FIGS. 1A-C are a general overview of an embodiment of a system architecture 50 for processing insurance claims in keeping with the disclosed principles. The elements of the system 50 are discussed below.

### Element 51. Perimeter Security for Global Claims Online Application.

The perimeter security 51 can be provided to selectively allow only authorized users 40 access to the global claims online application. Security measures can be provided to restrict the access of authorized value chain partners 45 and both internal and external users 40.1, 40.2, 40.3 to role-based access to selected portions of the global claims online application which are used to perform the particular role of the authorized user.

51.1. Perimeter Security Application <<SiteMinder>>.

Perimeter security can be provided by any suitable computer application 51.1 for monitoring and controlling access to global computer networks and web sites on global computer networks, such as SiteMinder® commercially-available from Netegrity, Inc. of Waltham, Mass., for example. The perimeter security application 51.1 can provide a centralized, web-access control system that enables user authentication and single sign-on, authentication management, policy-based authorization, identity federation, and auditing of the access to web applications and portals. The perimeter security application 51.1 provides an enterprise web access management system that is highly manageable, reliable and scalable.

51.2 Web Server <<IBM HTTP Server>>.

The web server 51.2 can include a suitable web server program, such as the IBM HTTP web server program, which operates by accepting HTTP and HTTPS requests from the client and providing an HTTP or HTTPS response to the client.

51.3. SiteMinder LDAP.

The SiteMinder LDAP 51.3 is an application protocol for querying and modifying directory services running over TCP/IP. CA SiteMinder provides a centralized approach to password services that supports LDAP directories. This facilitates the creation of common password policies that define rules and restrictions governing password expiration, composition, and usage and that can be applied across the enterprise.

### Element 52. Message Level Security Layer for Value Chain Partners.

The message level security layer 52 helps provide the secure transfer of data and secure connectivity between the value chain partners 45 and the insurance company. The message level security layer 52 can validate web service requests via a Client Certificate (Security) and XML Messages (WSDL & Schema). SFTP and SOAP messages can be sent to and from the web-service-enabled web site.

52.1. XML Security Appliance—External Domain <<DataPower in DMZ 1>>.

The XML Security Appliance 52.1 (e.g., DataPower) provides an XML threat-reduction and security-enforcement layer for XML messages and Web services transactions, including encryption, filtering, digital signatures, schema validation, WS-Security, XML access control, XPath and detailed logging. The appliance 52.1 includes easy-to-use XML Firewall, service-level management, and access-control enforcement. The appliance 52.1 can be equipped such that XML messages are validated as they enter and/or exit the appliance 52.1. Hardware and/or software customized for efficient XML parsing and analysis can also be provided.

52.2. Client Certificate Module.

To provide a secure means for user interface communications, a client certificate module 52.2 can be provided. Client certificate authentication allows users to present client certificates to authenticate with an Incoming Web Requests listener. When the certificate is validated, the user will be able to connect to the Incoming Web Requests listener and subsequently authenticate with the internal network web server using an alternate method of authentication (integrated, basic, digest).

### Element 53. Pass Valid External Web Service Request.

The element 53 helps provide a secure pass through for external-facing users to yield multilevel security capabilities. The gateway design pattern is used to control the flow and access to the inside world from the outside world. This includes security and other aspects such as quality of service.

53.1. XML Security Appliance—External Domain <<DataPower in DMZ 1>>.

The Sub-Element 53.1 is the same as the Sub-Element 52.1.

53.2. XML Security Appliance—Internal Domain <<DataPower in DMZ 2>>.

The Sub-Element 53.2 is the same as the Sub-Element 52.1.

53.3. WSDL and Schema Repository <<DataPower>>.

The WSDL and Schema Repository 53.3 is an integrated service registry and service metadata repository that contains information about a plurality of services, such as the service interfaces, its operations and parameters. The repository 53.3 is provided to store WSDL and schema and provide dynamic end point and services capability in an integrated fashion.

The WebSphere Service Registry and Repository (WSRR) 53.3 is the master metadata repository for service descriptions. As the integration point for service metadata, WSRR 53.3 establishes a central point for finding and managing service metadata acquired from a number of sources, including service application deployments and other service metadata and endpoint registries and repositories, such as UDDI. It is where service metadata that is scattered across an enterprise is brought together to provide a single, comprehensive description of a service.

53.4. Client Certificate.

The Sub-Element 53.4 is the same as the Sub-Element 52.2.

### Element 54. Global Claims Online Application <<Pega Process Rules Commander Instance on WebSphere Application Server Network Deployment (ND)—Clustered Mainframe Region/LPAR>>.

The Global Claims Online Application 54 can provide real time and near real time capabilities in all channels from the user interface to voice, fax, file transfer and interactive voice response/computer telephony integration (IVR/CTI). The Global Claims Online Application 54 can provide the claim components to enable the core capabilities for claim components. In some embodiments, the Global Claims Online Application 54 can be implemented in a Pega Rules Process Commander (PRPC) Instance on a WebSphere Application Server Network Deployment (ND). The application 54 can be stored in a clustered mainframe region/LPAR.

54.1. User Interface Layer <<Pega Claimant, Third Party, Internal User>>.

The Global Claims Online Application 54 can include a user interface layer 54.1 to provide the interface with the Global Claims Online Application 54 and for human to human interactions. The PRPC 54.1 of the Global Claims Online Application 54 can support a wide range of user interaction facilities and approaches based on HTML and XML standards. The user interface 54.1 of the Global Claims Online Application can invoke business data services.

54.2. Workflow Management Module <<PRPC>>.

The Global Claims Online Application 54.1 can include a workflow management module 54.2 that can manage work flow of a set of work objects for the processing of a given insurance claim at the individual claim, adjuster, workload, manager and process levels. Flows are the fundamental rule instances that represent business processes, identifying who works on a work object in what sequence, what decisions and processing occur automatically, and many other aspects of the business process.

54.3. Business Event Monitoring Module <<PRPC>>.

The Global Claims Online Application 54 (through PRPC) can include a business event monitoring module 54.3 which provides real-time tracking of business events, including the tracking of business processes, operational activities, and business situations. The business events that drive business activity monitoring can be sent by a variety of conventional applications and technologies as will be appreciated by one skilled in the art.

54.4. Alerts and Notifications Module <<PRPC>>.

The Global Claims Online Application 54 can include an alerts and notifications module 54.4 which can provide information about operational and system health, thereby supporting proactive system management and monitoring. Developers and system administrators can use this information to quickly identify, diagnose, and remediate system and operational issues that may be degrading or compromising performance, stability, and scalability.

With respect to performance, an alert log can be generated that contains diagnostic messages that identify individual system events that exceed performance thresholds or failures. Alert messages can contain a set of field values that identify the alert, the conditions that caused it, and the state of the system when it occurred.

With respect to stability, a stability log can be provided that gathers system errors, exceptions (with their stack trace statements), debug statements, and any other messages not specified as alerts. The stability log can contain messages created by user activities as well as messages created by standard rules. With respect to scalability, a Java Virtual Machine (JVM) garbage collection (GC) log provides insight into how a java application makes use of memory.

54.5. Logging and Audit Trail Module <<PRPC>>.

The Global Claims Online Application 54 can include a logging and audit trail module 54.5 that monitors the activities of the application and provides a log for processes owned by the application. The logging and auditing features provide output contributing to the proactive capability of operations, applications and system management to help discover and resolve issues before the adversely impact the end user.

54.6. Task Management Jobs Module <<PRPC>>.

The Global Claims Online Application 54 can include a task management jobs module 54.6 that monitors the tasks of the application and provides proactive application control for processes owned by the application. The internal application management augments the overall task management solution.

54.7. Business Rules Management Module <<PRPC>>.

The Global Claims Online Application 54 can include a business rules management module 54.7 that manages a set of business rules created for processing insurance claims. Business rules can be implemented in the Global Claims Online Application 54. Any rules that need to be made available to other applications can be exposed as web services.

54.8. Internet Application Monitoring Module <<Proactive Net>>.

The Global Claims Online Application 54 can include an internet application monitoring module 54.8. The module 54.8 can comprise any suitable means for monitoring the application, such as Proactive Net, for example. Proactive Net is a real-time analytics solution that detects performance abnormalities in the IT environment, delivers early warning of degrading performance, and reduces time from issue detection to resolution. The early warning delivered by the use of “intelligent events” can be provided by analyzing and correlating data across the monitored IT infrastructure. This can speed the ability to detect abnormal trends before end users and mission critical applications are impacted.

The internet application monitoring module 54.8 can be configured to monitor the network environment and provide proactive control for network processes in the environment it is monitoring. The module 54.8 can delivers value in days, get “smart” within 2-4 weeks, and adapt to changes in performance behaviors automatically. The module 54.8 can reduce mean-time-to-repair by delivering probable cause analysis to the right people before users are affected; correlate performance, business, and other third party data and events to provide complete visibility into IT performance and business processes; reduce false positives; propagate only events closest to the problem cause with built-in event and data pre-processing; and adapt to changes in IT infrastructure automatically, factoring seasonal and business related aspects into the early warning.

54.9. Framework Monitoring Module <<Pega AES Monitor>>.

The Global Claims Online Application 54 can include a framework monitoring module 54.9. A suitable service, such as Pegasystems Autonomic Event Services (PegaAES), for example, can provide proactive monitoring of the PRPC application and inherent framework. This application automatically monitors, retrieves, and organizes performance-related alert log data from multiple nodes into reports and charts. PegaAES provides details about the events that triggered the alerts and the degree to which they are hindering system performance. Having gathered the alert data, PegaAES aggregates key alerts into work objects (action items) for monitoring and resolution. PegaAES assesses their severity, explains why the action items were created, and suggests how they can be fixed.

54.10. Pega Database <<Physically On Database Region/LPAR Cluster>>.

The PegaRULES database 54.10 includes tables that hold all the rules, data instances, work objects, history, and other concrete objects from internal classes of the Process Commander system. Views, indexes and stored procedures support performance and other processing requirements.

Every persistent object in the PegaRULES database 54.10 can have an associated class (Rule-Object-Class rule type). Process Commander uses a simple algorithm and information in Data-Admin-DB-Table instances to determine which table contains objects of which classes. When in memory and on the Clipboard, objects are known as instances and have an XML-like structure consisting of property names and text property values. These can be reviewed with the Clipboard tool.

### Element 55. Service-Oriented Architecture (SOA) and Business Process Modeling (BPM) Enabling Components <<Clustered Mainframe Region/LPAR>>.

SOA and BPM-enabling components 55 enable business process modeling and design, human interaction and collaboration, process execution, and business activity monitoring and analysis. BPM and SOA can allow processes to become more flexible and responsive. SOA can provide a flexible IT architecture to dynamically assemble services into orchestrated processes. Existing IT services and assets can become more valuable through reuse and provide faster time-to-value for new applications.

55.1. System Process Orchestration <<IBM WebSphere Process Server (Process Server)>>.

All automated workflow can be handled by a process server 55.1. Workflow management can be handled by a suitable business process management application, such as one commercially available from Pegasystems Inc. of Cambridge, Mass. Message level security can be used. All database access outside of Pega can be made via web services using a suitable web services description language document (WSDL).

A process server instance is preferably built on open standards. The process server 55.1 can deploy and execute processes that orchestrate services (information, systems, and trading partners) within the Global Claims SOA.

A WebSphere Process Server 55.1 can be used to help support a SOA infrastructure with one common model to orchestrate, mediate, connect, map, and execute the underlying IT functions. The WebSphere Process Server 55.1 design can simplify the integration of business processes by leveraging existing IT assets as reusable services, but without the complexities associated with traditional integration methodologies. Business flexibility can be achieved through standardizing, automating, and integrating key business processes and managing the performance of these processes.

55.2. Error Queues <<Process Server Queues>>.

The use of error queues 55.2 by domain can enable processing to continue in a synchronous or pseudo-synchronous manner while providing for processing of errors and/or business events when processing capabilities return to a normal state. This feature provides for end-user notification that certain events, under certain conditions, did not process as would normally be assumed using a real time synchronous model.

The ideal state of the error queues 55.2 is empty. The system acts to maintain an empty state.

55.3. Content and Context Router <<IBM Process Services Fabric—when Needed>>.

A content and context router 55.3 can be provided that is instantiated on top of a WebSphere ESB. The content and context router 55.3 can enable dynamic business services that can be personalized and adapted based on context, content and contract. The content and context router 55.3 provides for the means to select services dynamically at run time based on the context, content and the contract of the service request. The fabric utilizes a set of policies to select the service based on the qualities of the service such as availability, cost, reliability, etc.

55.4. Middleware Monitor Agents Module <<ITCAM for SOA>>.

A SOA infrastructure management software application 55.4 can be included to provide integrated management tools that speed and simplify identification and resolution of SOA problems. In some embodiments, the ITCAM suite of monitoring tools (IBM Tivoli Composite Application Manager for SOA), commercially available from International Business Machines Corp. of Armonk, N.Y., can be used. IBM Tivoli Composite Application Manager (ITCAM) for SOA Platform can provide an integrated offering for SOA management across the services, application, and middleware layers.

ITCAM for SOA allows the ESB to be fully monitored and managed. It can provide:

1. specific problem identification and failure;

2. service management automation;

3. heterogeneous SOA platform support;

4. an integrated console; and

5. application life-cycle management.

The ITCAM for SOA Platform combines the strength of in-depth Web services management with the management of IBM WebSphere® Application Servers, WebSphere MQ, and WebSphere Message Broker systems to deliver the information required to help meet demanding service levels required of SOA-based applications. When problems arise at the services layer, a launch-in-context capability of the application and messaging management components of ITCAM for SOA Platform can help find the root cause.

55.5. WPS CEI DB.

CEI DB is the database 55.1 that supports the Common Event Infrastructure (CEI) for monitoring business events. This is a work in progress database 55.5 that can be used to maintain transaction state and memory caching.

55.6. Enterprise Service Bus (ESB)<<WebSphere ESB>>.

All SOA message routing can be accomplished by an enterprise service bus (ESB) 55.6 which comprises a software architecture construct to process service requests via an event-driven and standards-based messaging engine (the bus). The ESB 55.6 can help centralize routing, which can be accomplished via static routing, deterministic routing, content-based routing, rules-based routing, and/or policy-based routing. The ESB 55.6 can provide support for synchronous and asynchronous transport protocols. The ESB 55.6 can be dependent upon contracts of behavior driven by functional and nonfunctional requirements. The ESB 55.6 can adopt, translate, and route a client request for a service to the appropriate answering service.

The ESB 55.6 provides the connectivity structure for SOA. The ESB 55.6 comprises a flexible architecture for application connectivity. It represents a secure single point of connectivity which simplifies programming, improves consistency, and increases flexibility.

The ESB 55.6 is part of an enterprise messaging system that can monitor and control the routing of message exchanges between services, resolve contention between communicating service components, and control the deployment and versioning of services. Messages are routed through the ESB 55.6 for buffering (message queuing) to hold the message if an application becomes temporarily unavailable, to accommodate applications working at different speeds, and to allow for inspection and enhancement of content, filtering, correction, and re-routing of message flow. The ESB 55.6 helps reduce the number of point-to-point contacts from and to a particular application to help enhance the ability to make changes and to monitor performance.

The ESB 55.6 can be adapted to make all direct contact with the applications on the bus. The contact can occur through the use of an enterprise message model which defines a standard set of messages that the ESB 55.6 will both transmit and receive. When the ESB 55.6 receives a message, it routes the message to the appropriate application. In cases where that application evolved without the same message-model, the ESB 55.6 can transform the message into a format that the application can interpret.

5.7. Global Claims Domain <<Service Routing Table>>.

The SOA and BPM enabling components 55 can include a global claims domain 55.7 implemented as a service routing table. The service routing table 55.7 facilitates the routing between all the communication technologies through a consistent naming and administration model. The service routing table 55.7 maintains and updates end point and mediation points for dynamic service description and addressability.

55.8. In-country Domains <<Service Routing Table>>.

The SOA and BPM enabling components 55 can include in-country domains 55.8 each implemented as a service routing table. This Sub-Element 55.8 helps maintain and update end point and mediation points for dynamic service description and addressability. Since in-country services will have domain-specific end points and routing needs that change over time, domain drives the definition of the service routing tables.

55.9. Client Certificate, WSDL and Schema store or access point.

The Sub-Element 55.9 helps selectively permit access and provide content based perimeter security. Client certificates can be provided that contain information that identifies the user, as well as information about the organization that issued the certificate. Certificates can be exchanged between users and the application to help secure individual transactions.

The WSDL can be an XML format for describing network services as a set of endpoints operating on messages containing either document-oriented or procedure-oriented information. The described abstract operations and messages can then be bound to a concrete network protocol and message format to define an endpoint. The related, combined abstracted concrete endpoints (services) describe the services. WSDL is preferably extensible to allow description of endpoints and their messages regardless of what message formats or utilized network protocols are used to communicate.

55.10. Middleware Monitor Agents <<ITCAM for SOA>>.

The Sub-Element 55.10 is the same as the Sub-Element 55.4. The activities, upon configuration of the tools, provide monitoring of system management activities for the middleware components.

### Element 56. Global Claims Message Queue Module <<IBM MQ>>.

The system can include a global claims message queue module 56. The queue managers provide messaging capabilities for the Global Claims System. A Global Claims message queue module 56, such as WebSphere MQ, for example, can be provided. The Global Claims message queue module 56 can provide reliable, resilient application integration by passing messages between applications and web services. The Global Claims message queue module 56 reduces the risk of information loss and the need to reconcile communicating IT systems by using queuing and transactional facilities that help preserve the integrity of messages throughout the network and guarantee delivery of each message. The Global Claims message queue module 56 can help eliminate the need to write complex communications code and offers a choice of simple APIs (Message Queue Interface and Java Message Service™) that are consistent through a range of supported operating environments, provided both by IBM and Business Partners, for example.

56.1. Transaction.

The Sub-Element 56.1 includes queues that handle transaction messaging. Transaction messages are routed, orchestrated and mediated through this purpose-built queue. The depth of the queues 56.1 is dependent upon transactional volume.

56.2. File.

The Sub-Element 56.2 includes queues that handle file transfers. The depth of the queues 56.2 is dependent upon file-to-queue and queue-to-file transfer.

56.3. Back out.

The Sub-Element 56.3 includes queues that handle back outs related to error management. The depth of the queues 56.3 is dependent upon error volume. The ideal state of these components is empty.

### Element 57. Data Integration Hub <<DataStage, Ab Initio—Clustered Mainframe Region/LPAR >>.

A data integration hub 57 can be provided to integrate data on demand with a high performance parallel framework, extended metadata management, and enterprise connectivity. The data integration hub 57 supports the collection, integration and transformation of large volumes of data with data structures ranging from simple to highly complex. The data integration hub 57 can provide a scalable platform that enables an insurance company to solve large-scale business problems through high-performance processing of massive data volumes with real-time data integration. The data integration hub 57 can also enable developers to maximize speed, flexibility and effectiveness in building, deploying, updating and managing the data integration infrastructure. The data integration hub 57 can facilitate complete connectivity between any data source and any application.

57.1. Automated Processing Jobs/Tasks Module.

A module 57.1 for automated processing jobs/tasks that provide data services can be invoked to support specific business functions in a controlled and consistent manner. This notion can provide for automation of data flow between different data stores to maintain integrity and quality of data.

57.2. Data Transformation Services Module.

A data transformation services module 57.2 can be used to carry out the process that extracts, transforms, and loads the data to the appropriate databases. The data transformation services module 57.2 can provide ETL services that include:
the metadata trapped by an ETL tool graphically documents source and target database structures, mappings, cleansing rules and transformation rules
construction of ETL scripts using a metadata-driven graphical tool with built-in data cleansing and transformation functions
mappings, extract rules, cleansing rules, transformation rules, aggregation logic and loading rules that are generally handled as separate objects
compartmentalization of individual functions that eases maintenance, limits the scope of change and reduces the need for retesting.

57.3. In-country Jobs Module.

A module 57.3 for in-country jobs that provide data services can be invoked to support specific business functions (e.g., policy verification, issue payment, or retrieval of legacy data from regional data bases) in a controlled and consistent manner. The in-country jobs module 57.3 can provide service enablement and common methods of delivery and can provide interfaces between legacy systems as well as interfaces to next-generation systems.

### Element 58. Web Services Cluster <<WebSphere Application Server Network Deployment (ND) Edition—Clustered Mainframe Region/LPAR>>.

A web services cluster 58, built on commercially available software such as WebSphere Application Server Network Deployment (ND), for example, can invoke services, process orchestration, and read/writes to queues. The web services cluster 58 can also call CRUD stored procedures and execute dynamic SQL. The web services cluster 58 can include clustering capabilities, edge components, dynamic scalability, high availability, and advanced management features for distributed configurations.

The web services cluster 58 can also include a dynamic cache service, which improves performance by caching the output of servlets, commands, web services, and JSP files. This cache replication to the other servers can help provide redundancy. The monitoring of the state of the dynamic cache can be enabled via the cache monitor application.

58.1. Correspondence Service Module <<Java Service—JEE—WS Transactions>>.

A correspondence service module 58.1 can provide a correspondence mechanism between the insurance company and the users based on user preferences (e.g., paper document, email, phone, and time preferences). The correspondence service module 58.1 can handle the requirements dealing with communicating with external parties using different modes of communication.

58.2. Vendor Management Service Module <<Java Service—JEE—WS Transactions>>.

A vendor management service module 58.2 can provide the activities required to manage the various aspects of working with vendors that are providing a service in support of the adjudication of a claim. The vendor management service module 58.2 can handle all aspects of interacting with external vendors which provide service, including sending and receiving information from them.

58.3. Middleware Monitor Agents Module <<ITCAM for SOA>>.

A middleware monitor agents module 58.3, such as, an IBM Tivoli Composite Application Manager (ITCAM) for SOA Platform, for example, provides an integrated offering for SOA management across the services, application, and middleware layers. The Sub-Element 58.3 can be the same as the Sub-Element 55.9. The middleware monitor agents module 58.3 can allow the ESB to be fully monitored and managed. The middleware monitor agents module 58.3 can provide for:

1. service problem identification and failure

2. service management automation and failure response

3. heterogeneous SOA platform support

4. integrated console

5. transaction life-cycle management

The middleware monitor agents module 58.3 can combines the strength of in-depth web services management with the management of commercially available software systems such as IBM WebSphere® Application Servers, WebSphere MQ, and WebSphere Message Broker to deliver the information required to help meet demanding service levels required of SOA-based applications. When problems arise at the services layer, the launch-in-context capability of the application and messaging management components of the middleware monitor agents module can facilitate the discovery of the root cause.

58.4. Client Certificate, WSDL & Schema store or access point.

The client certificate, WSDL and schema store or access point module 58.4, which can be built on commercially available software such as WebSphere™ Service Registry and Repository, acts as a service registry and is the master metadata repository for service descriptions. The Sub-Element 58.4 can be the same as the Sub-Element 55.10. As the integration point for service metadata, this repository 58.4 establishes a central point for finding and managing service metadata acquired from a number of sources, including service application deployments and other service metadata and endpoint registries and repositories. It is where service metadata that is scattered across an enterprise is brought together to provide a single, comprehensive description of a service.

### Element 59. Global Claims Data Repositories <<Fail Over Cluster on Mainframe LPAR (Database Cluster)>>.

The system 50 can include global claims data repositories 59 which can act as a centralized repository for storing integrated information related to a claim. The architecture need only search in one place to look for all data surrounding a claim (i.e. provides for a single access point). The global claims data repositories 59 can present consistent views and uses of information, thereby increasing the accessibility of data and its ability to be shared.

59.1. Claims Transactional Database.

A claims transaction database 59.1 contains dynamic transactional data and is used for operations of the claims system. The claims transaction database 59.1 can simplify the tracking of claims by providing a single place to look for all data surrounding a given claim.

59.2. Claims Data Warehouse.

A claims data warehouse 59.2 can contain aggregated data from an Operational Data Store. The claims data warehouse 59.2 can be used for management reporting. Information is loaded into the warehouse 59.2 from the operational data store. Information is cleansed and organized for efficient query and analysis. Data marts, which are subsets of the data in the claims data warehouse, can be provided. The data marts can be consolidated and summarized to provide efficient reporting and analysis for a specific set of user requirements.

59.3. Claims ODS Database.

A Claims Operational Data Store (ODS) database 59.3 can contain consolidated information from all claims databases, including both in-country database(s) and the global claims transactional data base. The Claims ODS database 59.3 can be used as a read-only data base for operational reporting and for improving the performance of the transactional data bases.

59.4. Database Monitor <<ITCAM for DB2>>.

A database monitor module 59.4, such as ITCAM for Applications—Database Support, for example, monitors performance and availability metrics for database servers, including IBM DB2®, Oracle, Informix and Sybase database servers. The database monitor module 59.4 can provide intelligent monitoring and management of database servers. The database monitor module 59.4 can provide standard views that show metrics unique to each application, including buffer hits, connections used, thread activity, deadlocks and contention.

59.5. CRUD Stored Procedures Module.

CRUD (create, read/retrieve, update, delete/destroy) refers to major functions implemented in relational database applications. A CRUD stored procedure module 59.5 can provide services to read, write to, and update the physical data bases. The CRUD stored procedures module 59.5 can maintain data integrity and quality. The CRUD stored procedures module 59.5 can implement stored procedures that can be used for complex SQL involving multi-table joins or unions.

When any application calls a stored procedure, it processes data in a consistent way according to the rules defined in the stored procedure module. If rules need to change, the developer need only make the change once in the stored procedure, not in every application that calls the stored procedure. The CRUD stored procedures module 59.5 can reduce network traffic for distributed applications, help provides access to features that exist only on the server, facilitate the enforcement of business rules, and facilitate application integration solutions.

### Element 60. CI Services Gateway.

A CI services gateway element 60 can provide connectivity to existing CI services that are outside of the boundary of the Global Claims System 50. The gateway design pattern can be used to control the flow and access to the inside world from the outside world. The CI services gateway element 60 includes security and other aspects such as quality of service. Specific requested services can be provided based on the requested content, such as reporting services, vendor management services, etc.

60.1. CASL Web Services <<Authorization>>.

A CASL web services module 60.1 can provide enterprise level user and service authentication processing as well as a set of rules that defines who can see and interact with what data within an application. The CASL web services module 60.1 can be used for authorization of users of the Global Claims System 50.

60.2. Document Management Service.

A document management service module 60.2 can provide for the means to store, index, edit and retrieve documents for various purposes. Document management typically works with imaging and content management. The document management service module 60.2 provides facilities that allow for:
check in/check out of stored information to provide consistency during edit sessions;
version management to keep track of different versions of the same information with their revisions and renditions (same information in a different format);
search and navigation for finding information and its associated contexts; and
visualizing for showing information in structures like virtual files, folders, and overviews.

60.3. Document Generation Service.

A document generation service module 60.3 provides for the means to generate documents based on pre-defined document templates. The document management service module 60.3 can provide facilities that allow for the creation of templates and the generation of documents.

Element 61. Document Viewing Portal <<iView>>.

A document viewing portal 61, such as, the iView system, for example, allows a user to connect from the Global Claims System 50 to view documents stored in the content management system 60.2. The iView system 61 allows for a single sign on from the Global Claims System.

### Element 62. Reporting <<Cognos Infrastructure>>.

A reporting element 62 can be provided that transparently merges data on the fly from multiple systems—including data warehouses, operational systems, web services, and external data sources. A web-based interface supports extranet and intranet users. Users 40 can access reports in their language based on the language settings of their browser. Email capability provides a way to deliver reports to many recipients automatically.

The reporting element 62 provides an open, service-oriented, enterprise-class platform that provides a consistent view of all data—without requiring implementation of multiple tools or synchronization or switching of tools. The reporting element 62 can offer broad system management capabilities, yet operate from a single metadata layer.

62.1. Operational Reports.

An operational reports module 62.1 can provide application operational reports including types which:
monitor process assignments,
monitor processes, and
analyze process quality.
   The operational reports module 62.1 can provide different types of application operational reporting. List view rules and summary view rules support most reports and charts produced in process commander applications. These powerful and flexible rules can support user interactions as well as management reporting needs. A “monitor activity” workspace in the standard WorkManager portal can include a set of standard reports relating to open and resolved work objects, assignments, and history.

### Element 63. IBM Columbus Content Manager Hosting.

A content manager 63, such as the IBM® Content Manager Enterprise Edition, for example, can manage all types of content across multiple platforms, databases and applications. The content manager 63 can manage the lifecycle of all content—images, electronic documents, XML, streaming audio and video—and acts as the core repository for a portfolio of products that helps manage, share, integrate and deliver critical business information on demand, for multiple platforms, databases and applications.

The content manager 63 can include version control which manages multiple versions of documents and objects, including multiple versions of specific document annotations. ODMA support can allow for easy document access from ODMA V2.0-compliant Windows desktop applications. Multi-value attributes allow documents and other content types such as audio clips to be identified by multiple authors or composers. Index class subsets can allow system administrators to protect sensitive information by restricting views to specific subsets. Resource manager replication can allow remote locations to have local copies of centrally-stored documents.

### Element 64. In-Country Components.

In-country components 64 are those components that operate on systems that are outside of the data centers that support the Global Claims Application. These components 64 perform in-country services when needed by the Global Claims System 50. These can include the ESB delegation services enabled by the in-country ESB or in-country communications capability. This process can invoke appropriate in-country services as needed, like policy administration for proof of coverage, for example.

64.1. Delegated Services <<JEE—WS Transaction>>.

A delegated services module 64.1 can include services invoked through the Global Claims ESB that are performed by in-country components. Similarly the delegated services module 64.1 can invoke internal non-global claims web services requested via the internal domain security appliance and subsequently through the ESB (with message level security).

The delegated services module 64.1 can be used to delegate specific operations to web services which perform encapsulated, in-country business functions, ranging from simple request-reply to full business process interactions. These services can be new applications or just wrapped around existing in-country legacy systems to make them network-enabled. Under this regime, services can rely on other services to achieve their goals.

64.2. Existing In-country Assets <<Applications, Queues, Databases, Batch Jobs, Services, etc.>>.

Existing in-country assets 64.2 include in-country assets that are being leveraged to provide in-country services. Examples of in-country assets 64.2 include already existing, stand-alone applications and assets that can easily be integrated into the Global Claims System 50 by implementing a web service as an interface. This process will invoke appropriate in-country services as needed, such as policy administration for proof of coverage, for example.

64.3. Content Caching <<IBM Content Manager Federation>>

A global claims content caching module 64.3 can be used to manage sprawling information by using technology that can “federate” content sources. That is, rather than centralize information, the content caching module 64.3 can be designed to function with disparate content servers in different locations.

### Element 65. In-Country Message Queues.

The Element 65 is the same as the Element 56 above.

65.1. Transaction.

The Sub-Element 65.1 is the same as the Sub-Element 56.1 above.

65.2. File.

The Sub-Element 65.2 is the same as the Sub-Element 56.2 above.

65.3. Back Out.

The Sub-Element 65.3 is the same as the Sub-Element 56.3 above.

In some embodiments of a method for processing insurance claims, the method includes employing a process server to deploy and execute services of a service-oriented architecture comprising computer executable instructions stored on a tangible computer-readable medium. The executable instructions can perform steps for processing the insurance claim. A user interface layer of a global claims online application can be used to enter data about an insurance claim into the global claims online application. Service requests can be processed via an enterprise service bus (ESB). Business data services can be invoked using the global claims online application user interface layer to store the entered insurance claim data in a claim transactional database. Business orchestration can be invoked using a workflow management module of the global claims online application and the ESB to perform a sequence of work objects to be completed for processing the insurance claim.

Messages can be written to a global claims message queue server using the ESB. The messages from the queue server can be consumed using the ESB. A business event monitoring module of the global claims online application and the ESB can be used to monitor for messages in the message queue server.

Claims services of the service-oriented architecture can be deployed in response to an invocation received from the user interface layer. Data services of the service-oriented architecture can be deployed in response to an invocation received from the user interface layer. A data integration hub can be accessed and a data transformation service of the service-oriented architecture can be invoked to integrate claims data into a standardized data model. A web services cluster can be used to call CRUD stored procedures from a global claims data repository.

The process server can be at a first geographical site. A user interface channel including a user interface browser and a web server can be associated with the global claims online application to display the user interface layer at a second geographical site, which is not the same structure as the structure which houses the process server. Users from regions around the world can interface with the central global claims online application. An in-country server can be at yet another different geographical site, which is not the same structure as the structure which houses the process server. A delegated service from the in-country server can be invoked using the ESB. Send and receive queues of a global claims message queue server can be replicated in corresponding send and receive queues of an in-country queue server.

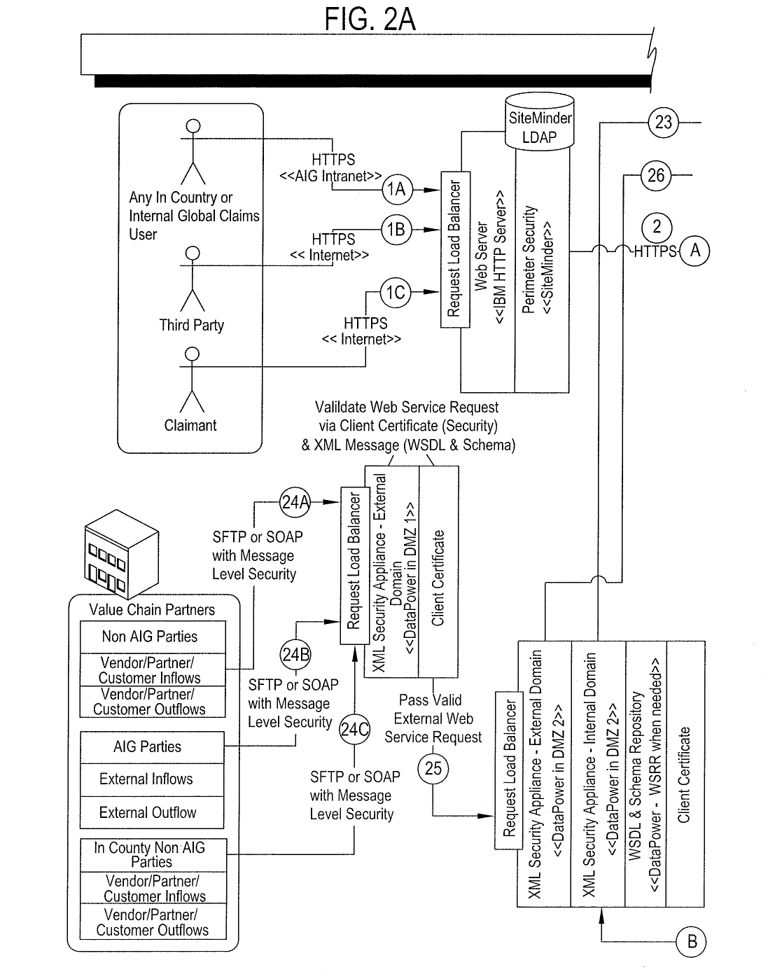

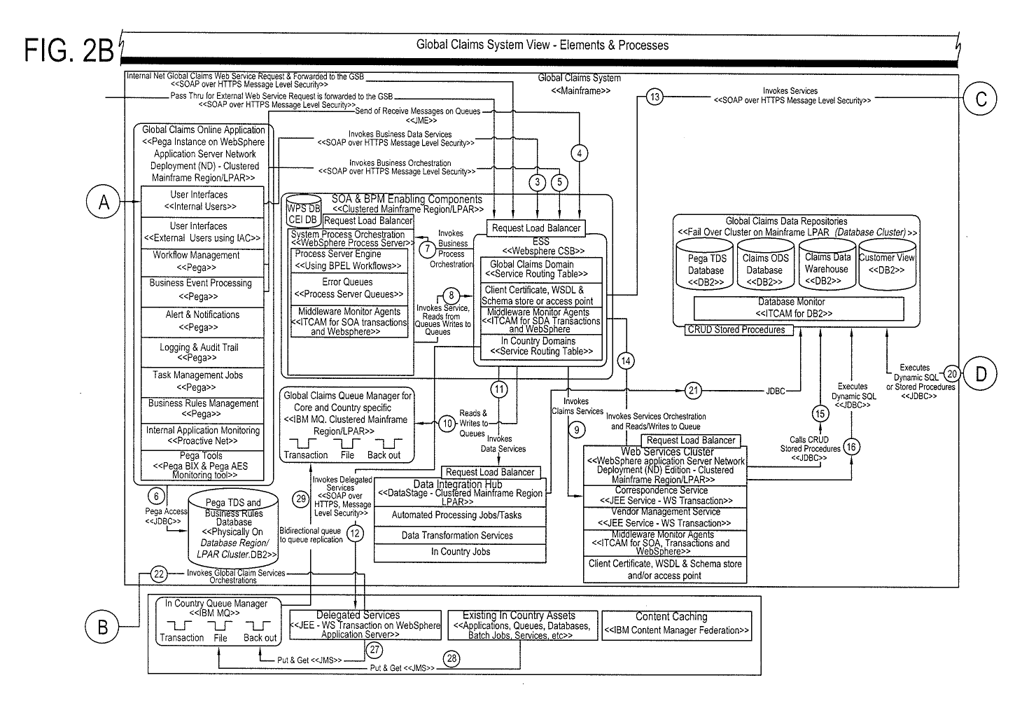

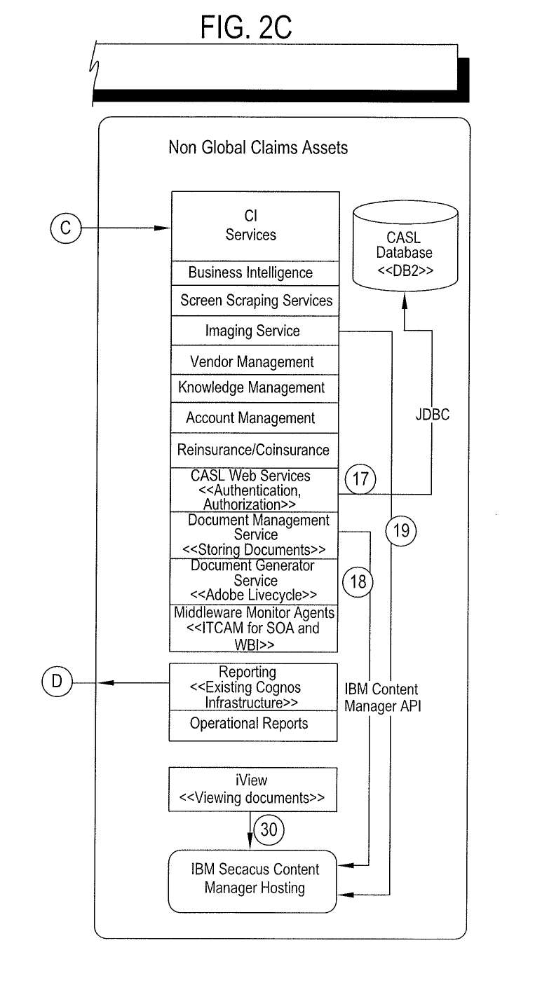

FIGS. 2A-C are a flow diagram that illustrates an exemplary method of an aspect of the present disclosure. The illustrated method is partitioned into process steps. It should be understand that the numbering of the following steps is for convenient reference only and should not be understood to imply or dictate an order in which the steps are performed.

### Step 1. Access User Interface Channel Using a User Interface Browser and a HTTP Server via HTTPS.

The user interface channel step (1) refers to the use of the Global Claims User Interface authentication and authorization process via the enabling elements using SOAP via Request—Reply Load Balancer—IBM HTTP Server via HTTPS—Perimeter Security SiteMinder/SiteMinder LDAP.

Step 1A. User Interface Channel—Any In-country User.

In this step (1A), any in-country user can be authenticated via the global claims user interface and authorized via the enabling elements using SOAP via Request—Reply Load Balancer—IBM HTTP Server via HTTPS—Perimeter Security SiteMinder/SiteMinder LDAP and the CASL web service.

Step 1B. User Interface Channel—Third Party.

In this step (1B), a third party can be authenticated via the global claims user interface and authorized via the enabling elements using SOAP via Request—Reply Load Balancer—IBM HTTP Server via HTTPS—Perimeter Security SiteMinder/SiteMinder LDAP and the CASL web service.

Step 1C. User Interface Channel—Claimant.

In this step (1C), a claimant user can be authenticated via the global claims user interface and authorized via the enabling elements using SOAP via Request—Reply Load Balancer—IBM HTTP Server via HTTPS—Perimeter Security SiteMinder/SiteMinder LDAP and the CASL web service.

### Step 2. Moving From Perimeter Security to Global Claims Online Application Using the Perimeter Security Application and the Global Claims Online Application User Interface.

In this step (2), user authentication and access authorization can be performed via the perimeter security provisioning. The resulting event processing can be consumed by the Global Claims Online Application based on the request and reply pattern.

### Step 3. Invoke Business Data Services Using the Perimeter Security Application and the Global Claims Online Application User Interface.

In this step (3), a user can use the UI layer of the Global Claims Online Application to enter data about a claim into the system and subsequently invoke business data services via the ESB over SOAP.

### Step 4. Listen for Messages on Queues Using the Global Claims Online Application Business Event Monitoring (BEM) Module and the ESB.

In this step (4), the BEM layer can invoke monitoring and business event services via the ESB over Java Message Service, for example.

### Step 5. Invoke Business Orchestration Using the Global Claims Online Application Workflow Management Module and the ESB.

In this step (5), the workflow management layer invokes services over SOAP that the ESB invokes as orchestration services.

### Step 6. Access the WIP Database Using the Global Claims Online Application and the PegaRULES Database.

In this step (6), the Pega-driven application provides access to its work in progress (WIP) database via Java database connectivity (JDBC).

### Step 7. Invoke Business Process Orchestration Using the ESB and the Business Process Orchestration System.

This step (7) relates to the response to an orchestration request by the ESB from the process server via SOAP/MQ/JMS.

Step 8. Invoke Service (Read from Queues and Write to Queues) Using the Business Process Orchestration System and the ESB.

This step (8) relates to the invoking of the appropriate level of orchestration by the ESB to the Process Server via SOAP/MQ/JMS.

### Step 9. Invoke Claims Services Using the ESB and the Web Services Cluster.

In this step (9), web services are invoked via the ESB to the WS Application Server.

### Step 10. Read and Write to Queues Using the ESB and the Global Claims Message Queue Servers.

In this step (10), the ESB writes messages to the queue servers and consumes messages from the queue servers.

### Step 11. Invoke Data Services Using the ESB and Data Integration Hub.

In this step (11), the ESB invokes a request for data services via the Data Integration Hub.

### Step 12. Invoke Delegated Services Using the ESB and In-Country Components.

In this step (12), the ESB delegation services are enabled by the in-country ESB or in-country communications capability. This step can invoke appropriate in-country services as needed, e.g. policy administration for proof of coverage.

### Step 13. Invoke Services Using the ESB and CI Services.

In this step (13), the ESB invokes a request for CI services.

### Step 14. Invoke Services, Orchestration and Read/Writes to Queues Using the Web Services Cluster and the ESB.

In this step (14), the web services cluster requests ESB, queue and orchestration services via the ESB.

### Step 15. Call CRUD Stored Procedures Using the Web Services Cluster and the Global Claims Data Repositories.

In this step (15), a request for CRUD stored procedures from the web services application server is made via JDBC to the data repositories passing through the database security layer.

### Step 16. Execute Dynamic SQL Using the Web Services Cluster and the Global Claims Data Repositories.

In this step (16), dynamic SQL is executed from the web services application server via JDBC to the data repositories passing through the database security layer.

### Step 17. Access the CASL Web Service Using the Web Services Cluster and the CASL Database.

In this step (17), the web services call the CASL web services over JDBC to obtain information about a user's fine-grained authorizations within the application, such as the type of claims the user may adjudicate and the user's financial authorities.

### Step 18. Manage Content Using the Document Management Service and the Content Manager Element.

In this step (18), the web service document management service provides a service request to the content manager or a request to create a document, deliver it via the appropriate method and store it in the content manager.

### Step 19. Invoke an Imaging Service Using the Imaging Service and the Content Manager Element.

In this step (19), the CI Services Gateways internal-external document management service provides a service request to the content manager.

### Step 20. Invoke a Reporting Service Using the Reporting and Global Claims Data Repositories.

In this step (20), a reporting request is issued to the global claims data repositories.

### Step 21. Access Data Integration Hub JDBC Using the Data Integration Hub and Global Claims Data Repositories.

In this step (21), a JDBC request is executed from the data integration hub to the data repositories passing through the database security layer.

### Step 22. Invoke Global Claims Services, Queue, and Orchestrations Using the Delegated Services and the XML Security Appliance—Internal Domain.

In this step (22), the in-country delegated services processes issue a request or response back to the Global Claims ESB via the entry point.

### Step 23. Forward Internal Non-Global Claims Web Service Request to the ESB Using the XML Security Appliance—Internal Domain and the ESB.

In this step (23), the in-country service request as described in Step 22 above is completed. The service request is processed using a validation of the web service request via client certificate (security) and XML message (WSDL and schema).

### Step 24. Invoke Externally-Exposed Service Using the Value Chain Partners and the XML Security Appliance—External Domain.

In this step (24), a value chain partner external service request is processed using a validation of the web service request via client certificate (security) and XML message (WSDL and schema).

Step 24A. SFTP (Secure File Transfer Protocol) or SOAP with Message Level Security for Non-Insurer Parties.

In this step (24A), a non-insurer value chain partner external service request is processed using a validation of the web service request via client certificate (security) and XML message (WSDL and schema) or presents a data set using SFTP as the transport mechanism to ensure the data security while it is flowing through the public Internet.

Step 24B. SFTP or SOAP with Message Level Security for Insurer Parties.

In this step (24B), an insurer value chain partner external service request is processed using a validation of the web service request via client certificate (security) and XML message (WSDL and schema) or presents a data set using SFTP as the transport mechanism to ensure the data security while it is flowing through the public Internet.

Step 24C. SFTP or SOAP with Message Level Security for In-country Non-Insurer Parties.

In this step (24C), an in-country non-insurer value chain partner external service request is processed using a validation of the web service request via client certificate (security) and XML message (WSDL and schema) or presents a data set using SFTP as the transport mechanism to ensure the data security while it is flowing through the public Internet.

### Step 25. Pass a Valid External Web Service Request Using the XML Security Appliance—External Domain and the XML Security Appliance—Internal Domain.

This step (25) relates to the pass through processing associated with a value chain partner request and its eventual routing to the Global Claims ESB via load balancing and the XML security appliance for external domains.

### Step 26. Request for External Web Service is “Passed Through” to the ESB Using the XML Security Appliance—External Domain and the ESB.

In this step (26), a service request to the ESB is invoked from an external source via SOAP over HTTPS to provide message security.

### Step 27. Delegated Services Send and Receive Messages Using the Delegated Services and In-Country Queues.

In this step (27), in-country delegated services send and receive messages from the in-country queues.

### Step 28. Existing In-Country Assets Send and Receive Messages Using Existing In-Country Assets and In-Country Queues.

In this step (28), existing in-country assets send and receive messages from the in-country queues.

### Step 29. Perform Queue to Queue Replication Using the Global Claims Core Queues and In-Country Queues.

In this step (29), Global Claims core queues and in-country queues are kept in sync via replication. The core queues include a send/receive pair of queues for messages flowing in each direction. The global claims application sends and receives messages from the core queues, and the in-country assets send and receive messages from the corresponding in-country queues.

Step 30. Access the Content Manager Element Using the iView System.

In this step (30), the iView application provides users with the ability to view documents stored in the Content Manager.

In other embodiments, the architecture of the system can be varied. For example, the following areas in the architecture can be varied: User, IT service, and data. The architecture can support variations in these three areas by declaring service policy use as a governance process, for example. The output of the governance processes can be captured in the service registry and repository.

The ability to add to, or manipulate, the core IT services that provide the data to the integration layer helps provide extensibility. When it is desired to make modifications, the recording of the new, changed or sunset service in the service registry and repository can provide the policy for the given service.

In some embodiments, the services can be changed or added without impacting the other layers. For example, there may be many places requiring additional functionality over time as the system is extended, such as the addition of new IT services, for example. As another example, it may be desirable to change the presentation layer inside the business application layer. The extension of existing portlets can provide new functionality required for a new region or country based on a common set of usability requirements.

Also, existing business rules may be edited, and new business rules can be added over time such that new business level behaviors can be supported. For example, different ways of performing subrogation based on the data in the claim or First Notice Of Loss (FNOL) may call existing services based on the service policy. Service declarations can provide additional business processes. For example, a business process can be exposed as a service that may be called from other services or business processes.

In other embodiments, systems and methods for processing an insurance claim may be implemented on various types of computer architectures, such as for example on a networked system, or in a client-server configuration, or in an application service provider configuration. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor can include but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the particular circumstances surrounding its use (e.g., located on client and/or server computers).

In various embodiments, methods for processing insurance claims in accordance with the principles of the present disclosure operate as software programs running on a computer processor. For example, in some embodiments, a non-transitory, tangible computer-readable storage medium can include instructions for processing insurance claims. The instructions, when executing on one or more computing devices, perform steps for processing an insurance claim. A web server can be used to display a user interface layer of a global claims online application on a user interface browser to receive data about an insurance claim. Service requests can be processed via an ESB. Business data services can be invoked in response to input from the global claims online application user interface layer to store the entered insurance claim data in a claim transactional database. Business orchestration can be invoked using a workflow management module of the global claims online application and the ESB to perform a sequence of work objects to be completed for processing the insurance claim.

Dedicated hardware implementations including, but not limited to, application-specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

In various embodiments, an insurance claim processing program in accordance with the principles of the present disclosure can take the form of a computer program product on a tangible, computer-readable storage medium having computer-readable program code means embodied in the storage medium. The software implementations of the insurance claim processing program as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, a tangible storage medium includes a distribution medium and art-recognized equivalents and successor media, in which the software implementations herein are stored. It should be understood that a variety of programming languages may be used to implement the teachings of the present disclosure as described herein, and any references to specific languages are exemplary to aid one skilled in the art to make and use the invention.

The present invention has been described in particular detail with respect to a limited number of embodiments. Those of skill in the art will appreciate that the invention may additionally be practiced in other embodiments. The particular naming of the components, capitalization of terms, the attributes, data structures, or any other programming or structural aspect is not mandatory, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present features of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above.

The language used in the specification has been principally selected for readability and instructional purposes. Accordingly, the disclosure is intended to be illustrative, but not limiting, of the scope of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description.

The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for processing insurance claims, the method comprising employing a process server to deploy and execute services of a service-oriented architecture comprising computer executable instructions stored on a tangible computer-readable medium to perform the steps of:
using a user interface layer of a global claims online application to enter data about an insurance claim into the global claims online application;
processing service requests via an enterprise service bus (ESB);
invoking business data services using the global claims online application user interface layer to store the entered insurance claim data in a claim transactional database;
invoking business orchestration using a workflow management module of the global claims online application and the ESB to perform a sequence of work objects to be completed for processing the insurance claim.

2. The method for processing insurance claims of claim 1, wherein the process server is at a first geographical site, and the computer executable instructions stored on the tangible computer-readable medium perform a further step of:
associating a user interface channel including a user interface browser and a web server with the global claims online application to display the user interface layer at a second geographical site.

3. The method for processing insurance claims of claim 2, wherein the computer executable instructions stored on the tangible computer-readable medium perform a step of:
deploying claims services of the service-oriented architecture in response to an invocation received from the user interface layer.

4. The method for processing insurance claims of claim 2, wherein the computer executable instructions stored on the tangible computer-readable medium perform a step of:
deploying data services of the service-oriented architecture in response to an invocation received from the user interface layer.

5. The method for processing insurance claims of claim 4, wherein the computer executable instructions stored on the tangible computer-readable medium perform a step of:
accessing a data integration hub and invoking a data transformation service of the service-oriented architecture to integrate claims data.

6. The method for processing insurance claims of claim 2, wherein the computer executable instructions stored on the tangible computer-readable medium perform a step of:
using a web services cluster to call CRUD stored procedures from a global claims data repository.

7. The method for processing insurance claims of claim 1, wherein the computer executable instructions stored on the tangible computer-readable medium perform a step of:
writing messages to a global claims message queue server using the ESB;
consuming messages from the queue server using the ESB;
using a business event monitoring module of the global claims online application and the ESB to monitor for messages in the message queue server.

8. The method for processing insurance claims of claim 1, wherein the process server is at a first geographical site, and an in-country server is at a second geographical site, the computer executable instructions stored on the tangible computer-readable medium perform a further step of:
invoking a delegated service from the in-country server using the ESB.

9. The method for processing insurance claims of claim 8, wherein the computer executable instructions stored on the tangible computer-readable medium perform a step of:
replicating send and receive queues of a global claims message queue server in corresponding send and receive queues of an in-country queue server.

10. A non-transitory, tangible computer-readable storage medium bearing instructions for processing insurance claims, the instructions, when executing on one or more computing devices, perform the steps of:
using a web server to display a user interface layer of a global claims online application on a user interface browser to receive data about an insurance claim;
processing service requests via an enterprise service bus (ESB);
invoking business data services in response to input from the global claims online application user interface layer to store the entered insurance claim data in a claim transactional database;
invoking business orchestration using a workflow management module of the global claims online application and the ESB to perform a sequence of work objects to be completed for processing the insurance claim.

11. A system for processing insurance claims comprising:
a physical computer-readable medium including a global claims online application, the global claims online application including:
a user interface layer adapted to allow a user to interface with the global claims online application,
a workflow management module adapted to determine a sequence of work objects to be completed for the insurance claim and to determine which user of a set of users works on each of the work objects relating to the insurance claim, and
a business rules management module adapted to manage logical rules for segmenting the insurance claim or a feature thereof to follow a predetermined workflow;
a physical computer-readable medium housing an enterprise messaging system having an enterprise service bus (ESB) adapted to route messages for processing service requests;
a processor adapted to execute the global claims online application contained on the physical computer-readable medium and to deploy and execute services of a service-oriented architecture through the ESB.

12. The system of claim 11, wherein the business rules management module of the global claims online application is adapted to manage logical rules for determining whether an insurance claim can be adjudicated automatically.

13. The system of claim 11, wherein the global claims online application includes a business event monitoring module adapted to provide real-time tracking of claim processing.

14. The system of claim 13, wherein the global claims online application includes an alerts and notifications module adapted to provide users operational information.

15. The system of claim 13, wherein the global claims online application includes a logging and audit trail module adapted to monitor the activities of the global claims online application and provide a log thereof.

16. The system of claim 11, further comprising:
a global claims data repository operably arranged with the processor through the ESB, the global claims data repository adapted to store integrated information related to an insurance claim.

17. The system of claim 16, further comprising:
a data integration hub operably arranged with the processor through the ESB, the data integration hub adapted to invoke a data transformation service of the service-oriented architecture to integrate claims data.

18. The system of claim 11, further comprising:
a web server operably arranged with the global claims online application, the web server adapted to display the user interface layer of the global claims online application on a user interface browser to receive requests from a user and send responses to the user.

19. The system of claim 18, further comprising:
a global claims queue module operably arranged with the processor through the ESB;
a physical computer-readable medium housing a web services cluster adapted to invoke services of the service-oriented architecture, process orchestration, and read/write to queues of the global claims queue module.

20. The system of claim 18, further comprising:
a physical computer-readable medium housing a perimeter security application adapted to provide a web access management system with different access permissions;
wherein the processor is adapted to execute the perimeter security application.
